(19) United States
(12) Patent Application Publication
(10) Pub. No.: US 2005/0093188 A1
(43) Pub. Date: May 5, 2005

(54) Binderless preform manufacture

(76) Inventors: Mark L. La Forest, Granger, IN (US); Nabil Abu Gharbieh, Granger, IN (US); Slawomir T. Fryska, Granger, IN (US); Allen H. Simpson, Buchanan, MI (US); Barry P. Soos, Mishawaka, IN (US); Alan E. Fatz, Centerville, OH (US); Raymond J. Cipra, West Lafayette, IN (US); Thomas H. Siegmund, West Lafayette, IN (US)

Correspondence Address: Larry J. Palguta;Honeywell Law Department, 3520 Westmoor Street, South Bend, IN, 46628, US

(21) Appl. No.: 10/764,149

(22) Filed: Jan. 23, 2004

Related U.S. Application Data
(60) Provisional application No. 60/514,903, filed on Oct. 29, 2003.

(51) Int. Cl. C01B 31/00

(52) U.S. Cl. 264/29.1; 425/438; 425/412

(57) ABSTRACT

The present invention makes use of loose fibrous material (for instance, chopped fibers) as reinforcement matrix material in the manufacture of carbon-carbon composites. In accordance with this invention, a constraint fixture is provided which can be separated from the mold. The constraint fixture has an internal shape corresponding to the shape of a desired preform component, with the internal shape being defined by a bottom plate (2), an annular ejector plate (3, 3′), a inner wall (10), an outer wall (4), and an annular top plate (11, 11′). The constraint fixture is normally made of metal, porous ceramic, or carbon material. The constraint fixture of the mold holds the loose matrix materials (fibers, along with any fillers and/or additives). The mold assembly itself is segmented, so that the constraint, fixture and the loose fill materials in the fixture can be removed and subjected to further processing as a unit. Such further processing may include Chemical Vapor Deposition or resin or pitch infiltration or Resin Transfer Molding. The preform matrix may remain in the constraint fixture through such processing steps as densification and until it is removed therefrom for final machining.

This application claims the benefit under 35 U.S.C. §119(e) of provisional application Ser. No. 60/514,903, which was filed on Oct. 29, 2003.

### FIELD OF THE INVENTION

This invention relates to the manufacture of carbon fiber reinforced composite articles—specifically, preforms for carbon-carbon composite materials. The present invention is concerned in particular with the manufacture of such composite articles (or preforms) configured for use as friction components, for instance in aircraft braking systems.

### BACKGROUND OF THE INVENTION

A great deal of developmental work has occurred in the field of manufacturing carbon fiber reinforced composite articles. For instance, U.S. Pat. No. 5,578,255 discloses a method for preparing carbon fiber reinforced carbon composites that comprises subjecting short fibers composed of bundles of multiple single fibers to fibrillation, preparing a sheet oriented in the two-dimensional random direction, impregnating the sheet so-obtained with resin pitches and laminating and molding the sheet, and subjecting the molded product to baking and densification treatments.

U.S. Pat. No. 6,517,769 B2 relates to a preform for producing a structural unit made of fiber reinforced material. The preform is insertable into a form tool used in process in which the preform is resin-impregnated and cured. The form tool comprises a metal form with an upper mold and a lower mold, with the metal form enclosing the preform. The preform body of the preform unit comprises reinforcing fiber material or layers of fiber material, arranged as a woven web, a knitted sheet, a nonwoven fleece, or an oriented or random fiber mat or batt. In a similar context, U.S. Pat. No. 5,766,534 relates to the manufacture of preforms using a matrix resin that forms a continuous phase around a reinforcing material that forms a discontinuous phase. The '534 patent teaches that the reinforcing material can be woven or nonwoven fibers, random fibers, monofilaments, chopped fibers, and the like, and that the reinforcing material is most preferably in the form of woven graphite fabric.

Somewhat more intricate approaches to preform reinforcement have also been developed. U.S. Pat. No. 5,160,471 teaches a fibrous preform production method which produces a preform in the desired shape by linking the preform onto a rigid shaping device by threads that traverse the preform and pass through holes in the shaping device. U.S. Pat. No. 5,733,494 teaches a Resin Transfer Molding preform that comprises a special inner layer disposed between two outer layers of nonwoven continuous filament reinforcing fiber. The special inner layer is formed by substantially uniformly dispersing the pieces of continuous filament sheet material onto the surface of a first sheet or mat of continuous filament reinforcing fiber material, and is then covered with a second sheet of continuous filament reinforcing fiber material. The resultant three layers are clamped together at their outer edge, heated, and shaped.

In addition to the material makeup of composite preforms, various aspects of the molds used to make them have been the subject of research and development efforts. U.S. Pat. No. 5,518,385 discloses a Resin Transfer Molding procedure in which a reinforcing material is positioned between two mold sections, which are separated from one another during evacuation of a vacuum chamber, thus maintaining the reinforcing material in a substantially uncompressed condition, in order to remove all gasses and/or liquids from the reinforcing material and the mold prior to resin injection. After evacuation, the mold sections are brought almost into engagement to substantially define a mold cavity and the resin is injected into the mold cavity. Prior to terminating resin injection, the mold sections are brought into engagement and final resin injection is performed. U.S. Pat. No. 5,441,692 teaches a Resin Transfer Molding system which includes encapsulating a fibrous sheet within a tool and a cover plate that together define an inner cavity. The tool, cover plate, and sheet are placed within the inner chamber of an autoclave, and pressure in the inner cavity is reduced to create a vacuum within the tooling. A resin is then introduced into the inner cavity. After the tool is filled with resin, the inner cavity is heated by the autoclave to cure and form a composite material.

US 2002/0185777 A1 disclosed an innovative modular mold assembly. In one orientation, the mold portions of the assembly are mountable to each other and to a mold base, such that the exposed surfaces define a substantially U-shaped continuous lay-up surface. In another assembly orientation, secondary engagement surfaces are mated such that a substantially curved lay-up is formed from the exposed surface. In yet another mold assembly orientation, a mold support surface is mounted to a subset of the mold portions, such that another lay-up surface is formed for composite components which require an extended portion. The invention of the '777 application is said to facilitate the manufacture of composite structure by providing for the manufacture of a plurality of composite components from a minimal number of modular mold portions.

Friction components in aircraft brakes made from fiber-based preforms are densified by procedures such as Carbon Vapor Deposition (CVD), resin or pitch infiltration, and Resin Transfer Molding (RTM). Generally, the fibers and any other materials such as fillers. and additives incorporated at the stage of making fiber-based preforms are held together by binders during the early stages of manufacture. Binders are especially important in random fiber-type preforms, where materials are added to a mold in a loose fill process and then compressed into the desired preform dimensions and density.

Binders, which are normally used in the random fiber manufacturing of aircraft brake preforms, are typically low carbon yielding. As such, they require multiple and costly manufacturing steps to reach high density levels (>1.8 g/cc) for better heat capacity and system weight reduction. Ideally, the use of binders based on polymeric materials is to be avoided. Consequently an alternative method to hold fillers and additives in place within the fibrous preform is desirable.

### SUMMARY OF THE INVENTION

This invention provides method of manufacturing preforms for brake friction components, which method comprises placing (loose) carbon fiber materials into a mold in the absence of binders, compressing said materials to a density suitable for Resin Transfer Molding or pitch infiltration, removing a portion of the mold containing the compacted materials in a constraint fixture, and subjecting said materials in said mold portion to Resin Transfer Molding or pitch infiltration to make a brake friction component preform. In a preferred embodiment, the brake friction components made in accordance with this invention are designed to be used as brake discs in aircraft landing systems.

The present invention thus makes use of loose fibrous material (for instance, chopped fibers) as reinforcement matrix material in the manufacture of carbon-carbon composites. In accordance with this invention, a constraint fixture is provided which can be separated from the mold. The constraint fixture has an internal shape corresponding to the shape of a desired preform component, with the internal shape being defined by a bottom plate (2), an annular ejector plate (3, 3′), a inner wall (10), an outer wall (4), and an annular top plate (11, 11′). The constraint fixture is normally made of metal, porous ceramic, or carbon material. The constraint fixture of the mold holds the loose matrix materials (fibers, along with any fillers and/or additives). The mold assembly itself is segmented, so that the constraint fixture and the loose fill materials in the fixture can be removed and subjected to further processing as a unit. Such further processing may include Chemical Vapor Deposition or resin or pitch infiltration or Resin Transfer Molding. The preform matrix may remain in the constraint fixture through such processing steps as densification and until it is removed therefrom for final machining.

In accordance with this invention, the loose fibers may be produced by chopping continuous fiber tow and the chopped fibers may be sprayed into the mold. Instead of using binder to give the preform coherency, in accordance with this invention binderless chopped fibers are pressed at a pressure of about 3-10 atmospheres to compact them to a density suitable for Resin Transfer Molding or pitch infiltration. Pressure is initiated and applied by a press (not shown) through press plate (11, 11′). Since the purpose of pressure at this stage is simply to give the preform structural coherence prior to densification, pressures of 3-10 atmospheres are suitable, although other pressures can be employed if desired. The locking constraint, which includes locking cams (5), serves to maintain pressure during processing.

This invention also provides a preform mold apparatus for brake friction components, which comprises a constraint fixture having an internal shape corresponding to the shape of a desired preform component, said internal shape being defined by a bottom plate (2), an annular ejector plate (3, 3′), a inner wall (10), an outer wall (4), and an annular top plate (11, 11′). The top and bottom plates of the constraint fixture are generally perforated, so that a preform residing therein may be densified by resin infiltration and similar processes. In order to facilitate loading of the mold with fibrous materials, the apparatus may be provided with annular inner (13) and outer (12) filling rings. These rings are in place during the mold filling step. They may be removed prior to or after compression of the preform in the constraint fixture. They will, of course, normally not be present when the preform is being densified.

This invention thus provides a means for moving a compacted preform directly to a resin/pitch infiltration or RTM process, without the need for a binder resin or a preliminary rigidifying step such as Carbon Vapor Deposition. The novel constraint fixture of the mold described in this invention holds the loose fill materials (fibers, fillers, additives) in the desired location without binder or the need to rigidify by CVD. Alternatively, one could insert woven or nonwoven fabric layers into the mold constraint apparatus of this invention. Once the preform is positioned within the constraint fixture, the loose fill material preforms (or even fabric preforms) can be densified by an infiltration process without the risk of delamination or other deterioration.

### BRIEF DESCRIPTION OF THE DRAWINGS

FIG. 1 is an exploded perspective view of a mold incorporating a constraint fixture in accordance with the present invention.

FIG. 2 is an upside-down perspective view of a partially assembled mold bottom.

FIG. 3 is a cut-away perspective view of a mold bottom.

FIG. 4 is a cut-away perspective view of a mold bottom and constraint fixture.

FIG. 5 is a perspective view of a mold bottom plate.

FIG. 6 is a perspective view of a mold locking cam.

FIG. 7 is a perspective view of a cam retainer plate.

FIG. 8 is a perspective view of a constraint fixture press plate.

FIG. 9 is a perspective view of a mold outer ring.

FIG. 10 is a perspective view of a constraint fixture ejector plate.

FIG. 11 is a perspective view of a perforated press plate.

FIG. 12 is a perspective view of a perforated ejector plate.

FIG. 13 is a detailed perspective view of a bottom plate.

### DESCRIPTION OF PREFERRED EMBODIMENTS

This invention provides a preform mold apparatus for brake friction components. The apparatus of the invention comprises a constraint fixture having a bottom plate (2) and an internal area corresponding in shape to the shape of a desired preform. That internal area is defined by an annular ejector plate (3, 3′), generally perforated, a inner wall (10), an outer wall (4), and an annular top plate (11, 11′), also generally perforated. The bottom plate (2) may advantageously comprises holes (21 ) to facilitated ejection of ejector plate (3,3′).

The apparatus may be used with annular inner and outer filling rings (13, 12) to facilitate loading of the mold with fibrous materials. Those rings serve to guide chopped fibers and any fillers or other additives into the internal area of the constraint fixture.

The apparatus of this invention may include locking means, e.g., a plurality of locking cams (5), to maintain the top plate in place in the constraint fixture once the top plate has been pressed down to constrain fibrous material in the constraint fixture, as described in detail hereinbelow.

The apparatus of claim 1 may further comprise means for lifting the constraint fixture out of a mold. One example of such lifting means includes an eyebolt (14) fixed in a hole (22) in bottom plate (2).

A preferred manner of employing the apparatus of this invention involves a method of manufacturing preforms for brake friction components, most preferably of aircraft landing system brake discs. This method, which is another embodiment of the present invention, comprises the steps of placing carbon fiber materials into a constraint fixture in a mold apparatus in the absence of binders, compressing said carbon fiber materials to form a fibrous matrix, removing the constraint fixture containing the compacted fibrous materials from the mold apparatus, and subjecting said materials in said constraint fixture to densification to produce a brake friction component preform. The carbon fiber materials may comprise loose fibers, and optionally can also be accompanied by fillers and/or additives.

Preferably, the loose fibers are produced by chopping continuous fiber tow and the chopped fibers are then sprayed into the constraint fixture. This embodiment of the invention is facilitated by lining the constraint fixture with a light veil prior to spraying the chopped fibers into the constraint fixture. The veil serves to keep the chopped fibers and other materials being sprayed into the mold from escaping through the perforations in the ejector plate.

Once the chopped fibers and any additional filler or additive materials have been placed into the internal area of the constraint fixture, they are pressed, e.g., at a pressure of about 3-10 atmospheres, to compact them to a density suitable for densification. This procedure permits the formation of a preform matrix without binders. As discussed above, the absence of binders at this stage facilitates the production of densified carbon-carbon preforms. Subsequent densification steps will generally include one or more of Resin Transfer Molding, resin or pitch infiltration, and Carbon Vapor Deposition.

In practicing this invention, the carbon precursor fiber materials (fibers in loose form or in woven or nonwoven fabric form, together with additives) are dispensed into or placed in the mold of the constraint fixture—configured in the shape of the preform desired—which is located in the mold. The preform materials are then compressed to the desired thickness and density, and subsequently locked into the constraint region of the mold, which will generally be at the bottom of the mold. The desired thickness and density of the preform will be determined by the intended ultimate use of the preform being manufactured. Fibers used in accordance with this invention are preferably polyacrylonitrile (PAN) fibers, such as are conventionally used in the fabrication of carbon-carbon composite parts. However, glass fibrous material or other reinforcing fibrous material, such as metal fibers and other synthetic fibers, may be used, depending upon the composite part to be fabricated.

The preform can remain in the constraint fixture until final machining. The mold is segmented, so that the perforated constraint fixture can be removed with the preform materials in it. The constraint fixture with the preform materials in it proceeds to the resin infiltration (or RTM) step, where the preform is infiltrated with high carbon yielding molten pitch under low pressure and/or vacuum. Another, empty constraint fixture is then placed on the mold base and under the top portion of the mold, the mold is assembled, and the preforming process is repeated.

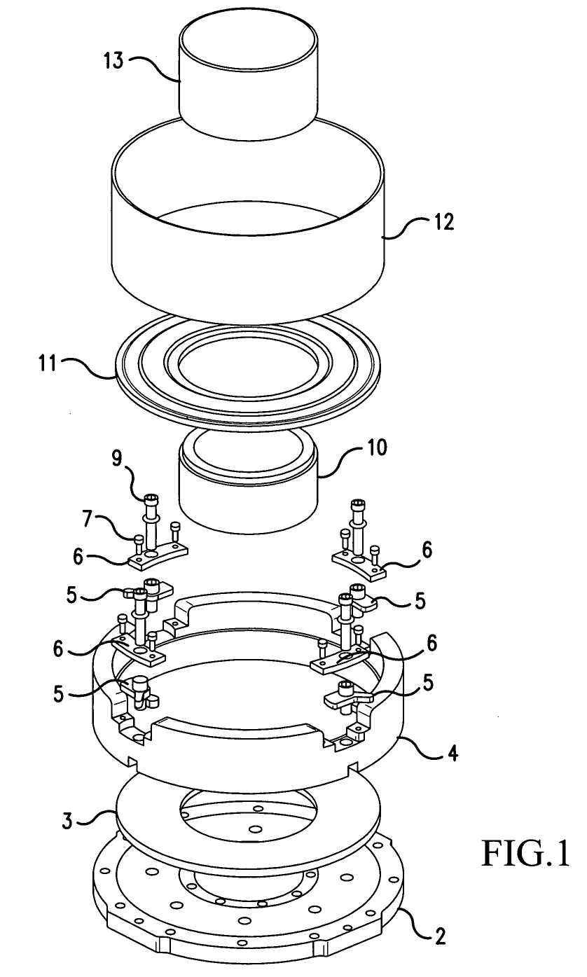

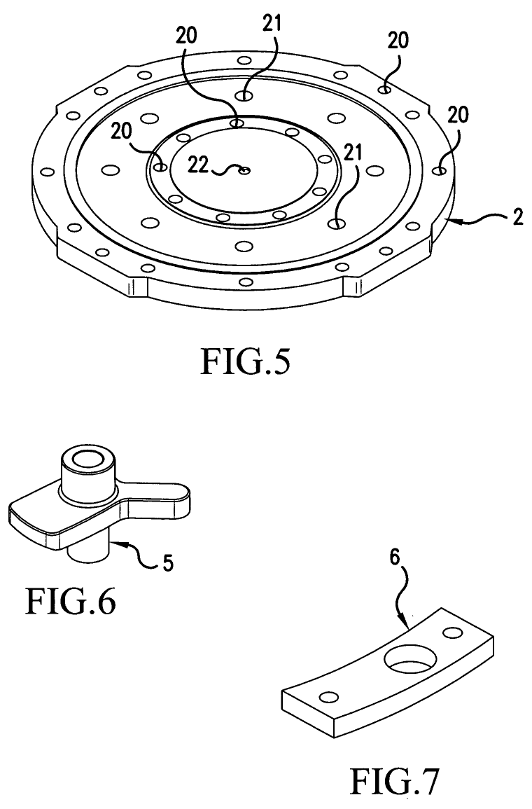

Referring to the drawings, FIG. 1 shows an exploded perspective view of a mold constraint fixture provided by this invention. The constraint fixture as depicted in FIG. 1 comprises a bottom plate 2, an ejector plate 3, a mold outer ring 4, a mold inner ring 10, and a press plate 11. FIG. 1 also identifies locking cams 5, cam retainer plates 6, retainer bolts 7, and cam locking bolts 9. The manner in which two cam retainer bolts 7 and one cam locking bolt 9 connect each cam retainer plate 6 to a corresponding locking cam 5 can be seen from their relative positions in FIG. 1. In this example, the locking cams are turned clockwise to lock the constraint fixture during use, and counterclockwise to unlock. After a preform being manufactured has been subjected to the pressing step, the locking cams 5 are swung down on the top of press plate 11 and are locked in position by locking bolts (9). Alternatively, a ratcheting device (not shown) can be used to automatically lock the press plate into position once the plate is pressed down to achieve the desired compaction or pressure. The function of lifting eye bolt 14 is explained in connection with the discussion of FIG. 5, below. Finally, FIG. 1 shows removable outer fill tube 12 and inner fill tube 13, which may be employed to facilitate loading loose preform materials into the mold constraint fixture.

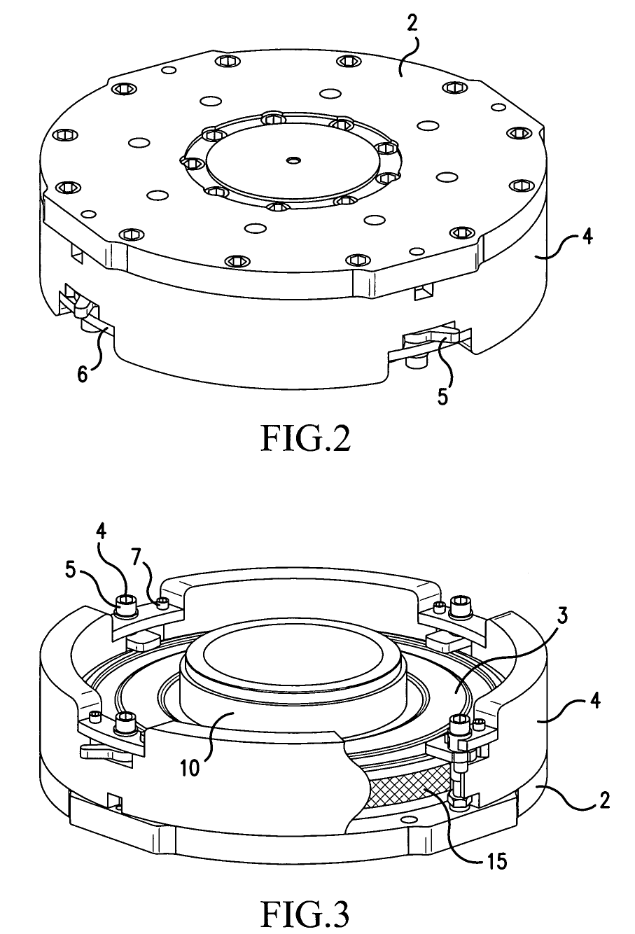

FIG. 2 is an upside-down perspective view of a mold constraint fixture bottom, showing bottom plate 2, outer ring 4, locking cam 5, and cam retainer plate 6.

FIG. 3 is a perspective view of a mold constraint fixture bottom, showing bottom plate 2, outer ring 4, ejector plate 3, inner ring 10, locking cam 5, cam locking bolt 9, and cam retainer bolt 7. Also visible in FIG. 3 is a preform 15 inside the mold. Preform 15 as shown in FIG. 3 is covered by a fabric veil, which serves to retain loose materials inside the mold constraint fixture.

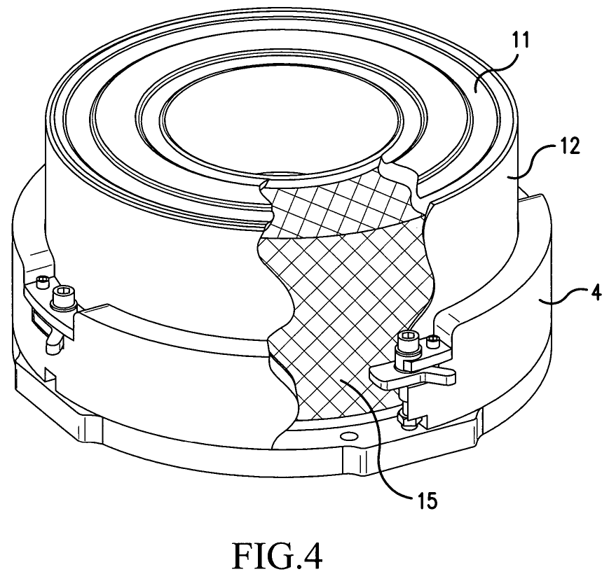

FIG. 4 is a perspective view of a mold constraint fixture, identifying outer ring 4, outer fill tube 12, and press plate 11. Also visible in FIG. 4 is a preform 15 inside the mold. Preform 15 as shown in FIG. 4 is covered by a fabric veil, which serves to retain loose materials inside the mold constraint fixture.

FIG. 5 is a perspective view of a mold bottom plate in accordance with the present invention. In FIG. 5, holes 20, located annularly in outer and centrally located portions of the bottom plate, are used for bolts which attach outer ring 4 and inner ring 10, respectively, to mold bottom 2. Holes 21 are present to permit ejection of ejector plate 3, by means of pins (not shown) which are pressed upwards through said holes 21. Eye bolt 14 (see FIG. 1) screws into hole 22 to permit lifting of the mold constraint fixture.

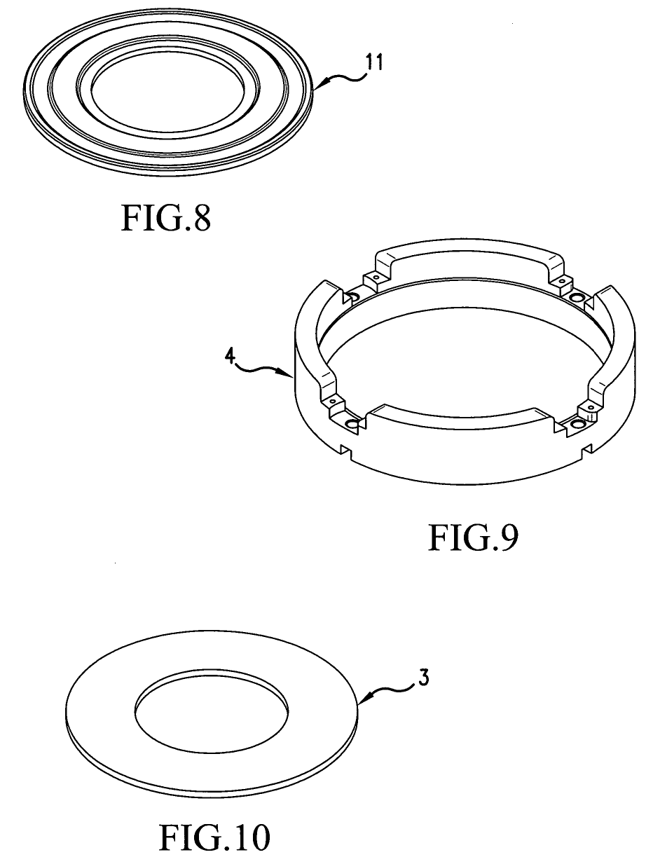

FIGS. 6 and 7 show larger perspective views of a locking cam 5 and a cam retainer plate 6, respectively. FIGS. 8-10 show perspective views of a press plate 11, a mold outer ring 12, and an ejector plate 3, respectively.

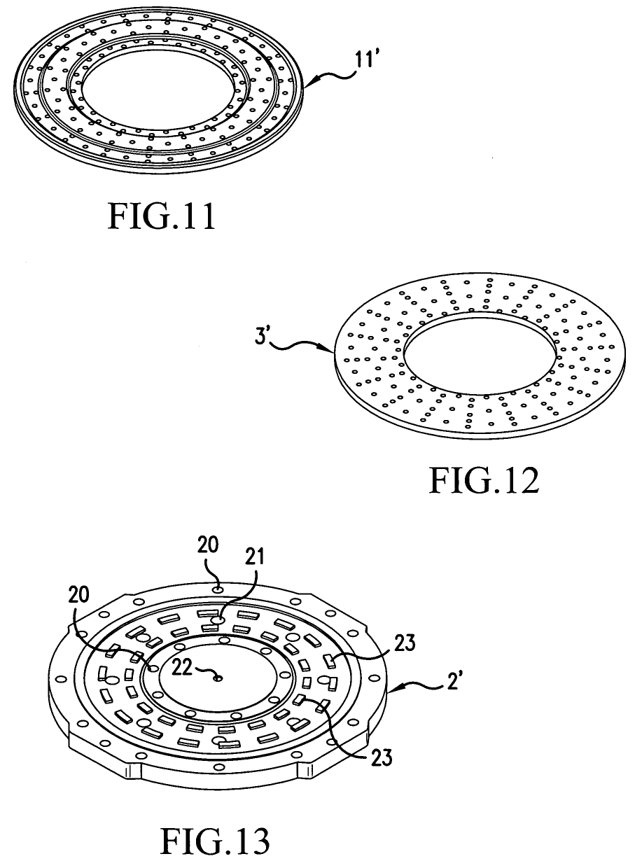

FIGS. 11 and 12 are perspective views of a perforated press plate 11′ and a perforated ejector plate 3′. When the preform mold constraint fixture of the present invention is to be used in RTM and CVD densification processes, the ejector plate and press plate are perforated, permitting gases and resin to circulate through the perforations.

FIG. 13 is a perspective view of a mold bottom plate 2′ in accordance with the present invention. In FIG. 13, bolt holes 20, ejector holes 21, and lifter hole 22 are indicated. FIG. 13 also shows risers 23, which serve to elevate ejector plate 3′ from mold bottom 2, thus facilitating the circulation of gases and resin through the perforations in an ejector plate 3′, for instance in CVD densification of a preform being manufactured.

Thus, in accordance with this invention, the bottom of the constraint fixture comprises a metal plate or ring-shaped disk that has perforations in the area upon which the carbon matrix fibers are placed. In use, the interior of the constraint fixture can be covered with a thin veil-like fabric, to prevent loose material from blowing or falling out through the perforations in the constraint fixture during mold filling or during compaction of the fiber matrix. The inner and/or outer walls of the constraint fixture may, likewise, be perforated. A perforated top plate assists in holding the loose fill materials (or preform-shaped woven or nonwoven fabric layers) in the desired location. The constraint fixture may, if desired, be made from materials other than metals, for instance ceramics or carbon. Although a manual locking system for the top plate is preferred, those skilled in the art will appreciate that locking can be automated with snaps, spring-loaded pins, etc.

The mold constraint fixture of this invention may be placed in a mold with a top half, a bottom half opposed to the top half so that the top half and the bottom half of the mold form a mold cavity, with at least one gate being disposed in the top half or the bottom half of the mold, a valve that can admit resin into the gate, and an arrangement for providing venting and/or vacuum to the mold.

Resin Transfer Molding processing of preforms manufactured in accordance with this invention includes: forming a porous preform in the mold constraint fixture described hereinabove; injecting a molten resin or pitch into the mold; permitting the resin or pitch to cool below its melting point; and removing the impregnated preform form the mold. The preform(s) can be heated to a temperature between about 290-425° C. (554-797° F.) either prior to or after being placed in the mold. The mold can be heated to a temperature between about 138-310° C. (280-590° F.).

The densified preform, following densification, can be treated at an elevated temperature in an oxygen-containing environment to effectively crosslink the thermoplastic resin. This process fixes the matrix in place within the preform and prevents softening, bloating, and/or expulsion of the matrix during subsequent heating about the resin melting temperature. Oxygen stabilization may entail heating the densified part in the presence of oxygen to a temperature less than the softening point of the resin, for instance to about 170° C. (338° F.). Additional treatments of the densified part may include carbonization, graphitization, and reimpregnation using RTM or CVD.

Resins that are contemplated by this invention include thermoplastic and thermoset liquid precursors such as for instance phenolic resins, furfuryl resins, and pitches derived from coal tar and petroleum. Also contemplated are synthetic, thermally treated, and catalytically converted pitches, mesophase pitches, and pre-ceramic polymers (such as CERASET, available from Commodore Technologies, Inc.). High char yield thermoset resins are particularly preferred.

As will be readily apparent to those skilled in the art, additives such as blowing agents (e.g., nitrogen gas), clays, silicates, carbon powders or fibers, antioxidants, and/or crosslinking agents may be added to the resin or pitch.

The present invention is particularly valuable in the manufacture of brake components, such as brake discs, for aircraft landing systems. The traditional process used to densify nonwoven preforms for aircraft brake applications is CVD. The preform will generally be previously resin-infiltrated, as described above.

The novel mold structure of this invention enables an improved handling and infiltration of preforms made from loosely filling a mold with fibers, additives, and fillers—without the necessity of adding binder thereto. The constraint fixture approach disclosed herein can also be utilized with other manufacturing processes in which thermoplastic or thermoset resins are to be reinforced with fibers, fillers, or other additives and subsequently molded. The novel mold structure of this invention (the constraint fixture) may also be used in the manufacture of preforms from nonwoven and/or fabric-type preforms, where needling or other means to bond the layers would conventionally be required prior to densification by CVD, resin/pitch infiltration, and/or RTM.

1. A preform mold apparatus for brake friction components, which apparatus comprises a constraint fixture having a bottom plate and an internal area corresponding in shape to the shape of a desired preform, said internal area being defined by an annular ejector plate, a inner wall, an outer wall, and an annular top plate.

2. The apparatus of claim 1, wherein the top plate and the ejector plate of said constraint fixture are perforated.

3. The apparatus of claim 2, wherein the bottom plate comprises holes to facilitate ejection of the ejector plate.

4. The apparatus of claim 1, further comprising locking means to maintain said top plate in place in the constraint fixture.

5. The apparatus of claim 4, wherein said locking means comprises a plurality of locking cams (5).

6. The apparatus of claim 1, further comprising annular inner and outer filling rings (13, 12) to facilitate loading of the mold with fibrous materials.

7. The apparatus of claim 1, further comprising means for lifting the constraint fixture out of a mold.

8. The apparatus of claim 7, wherein said lifting means comprises an eyebolt fixed in a hole in the bottom plate.

9. A method of manufacturing preforms for brake friction components, which method comprises the steps of
placing carbon fiber materials into a constraint fixture in a mold apparatus in the absence of binders,
compressing said carbon fiber materials to form a fibrous matrix,
removing the constraint fixture containing the compacted fibrous materials from the mold apparatus, and
subjecting said materials in said constraint fixture to densification to produce a brake friction component preform.

10. The method of claim 9, wherein said carbon fiber materials comprise loose fibers, and optionally, fillers and/or additives.

11. The method of claim 9, wherein said loose fibers are produced by chopping continuous fiber tow and wherein the chopped fibers are sprayed into the constraint fixture.

12. The method of claim 11, further comprising the step of lining said constraint fixture with a veil prior to spraying the chopped fibers into said constraint fixture.

13. The method of claim 9, wherein binderless chopped fibers are pressed at a pressure of about 3-10 atmospheres to compact them to a density suitable for densification.

14. The method of claim 9, wherein the densification step includes one or more of Resin Transfer Molding, resin or pitch infiltration, and Carbon Vapor Deposition.

15. The method of claim 9, wherein said brake friction component preform is configured as an aircraft landing system brake disc.
